(19) United States
(12) Patent Application Publication
(10) Pub. No.: US 2009/0016469 A1
(43) Pub. Date: Jan. 15, 2009

(54) ROBUST JOINT ERASURE MARKING AND LIST VITERBI ALGORITHM DECODER

(75) Inventors: Tao Li, Tsuen Kwan O (HK); Wai Ho Mow, Tsuen Kwan O (HK); Man Hung Siu, Kowloon (HK)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Kowloon (HK)

(21) Appl. No.: 11/776,050

(22) Filed: Jul. 11, 2007

(51) Int. Cl. H04L 27/06

(52) U.S. Cl. 375/341; 375/E07.001

(57) ABSTRACT

Joint erasure marking and list Viterbi algorithm (JELVA), decoder schemes, methods, and systems are provided which perform robust trellis decoder techniques and do not require an estimate of the impulsive noise distribution. Joint Erasure marking and Viterbi Algorithm (JEVA) is integrated with the list Viterbi algorithm (LVA) to form two-dimensional joint erasure marking and list Viterbi technique (2D JELVA) and switched JELVA technique. By combining the respective strengths of the JEVA and the LVA, the integrated decoding schemes are able to achieve significant performance gains over JEVA and achieve a wide range of performance-complexity-delay tradeoffs, according to system design considerations. The disclosed details enable various refinements and modifications according to decoder and system design considerations.

### TECHNICAL FIELD

The subject disclosure relates to decoding algorithms and more specifically to joint erasure marking and list Viterbi algorithm decoding including decoding in unknown non-Gaussian noise environments.

### BACKGROUND

In many real-world communication systems, the channel noise present at the decoder is impulsive noise as well as the background Gaussian noise. For example, in situations such as wireless communications, power line communications and digital subscriber line loops, the non-Gaussian distribution of channel noise results from the presence of impulsive noise in addition to the background Gaussian noise. In such situations, the conventional Euclidean distance based decoder may suffer from the problem of severe metric mismatch.

Various models have been developed to approximate the characteristics of such non-Gaussian noise. However, due to the time-varying nature of the impulsive noise, it is difficult to estimate its distribution accurately. As a result of metric mismatch in the decoder, this can lead to seriously degraded decoder performance. Moreover, the difficulty in selecting an appropriate noise model presents an additional problem. Type-based detection techniques have been proposed for unknown impulsive noise channels that make no assumptions on the noise Probability Density function (PDF). However, these schemes require training sequences, which introduce additional overhead to the transmissions.

One widely used suboptimal receiver that does not require the knowledge of the noise PDF and additional training sequence, is the concatenation of a nonlinear filter with a conventional Gaussian receiver. Commonly used nonlinearities include the limiter and hole puncher (blanker). It has been shown that the application of the nonlinear filter provides a performance improvement over the conventional Gaussian receiver alone in impulsive noise environment. The hole puncher can be interpreted as an erasure marker, where received signals that fall into particular regions in the signal space are erased. The rationale is that if a received signal is determined to be unreliable, it is better to ignore it rather than use it in further detection process.

Channel coding has also been applied to further mitigate the adverse effect of impulsive noise. The idealized erasure marker, where the impulse positions are exactly known, has been considered in combination with the hard decision Viterbi decoder and the turbo decoder. In one implementation, the received code symbols are first marked by the decision region based erasure marker and then sent to the Euclidean metric based Viterbi decoder to decode. However, the separation of the erasure marker and the decoder leads to less accurate detection of the impulse-corrupted symbols because the code structure is not exploited.

Another fundamental problem in modern wireless communication systems is caused by interference from other communication systems sharing the same frequency band. For example, IEEE 802.11g Wireless Local Area Network (WLAN) systems operates in the same frequency band as Bluetooth systems, which are narrowband frequency-hopping systems. For a typical 200 μs long WLAN packet, the probability of collision with a Bluetooth packet is more than 20%. However, the exact knowledge of the interference distribution is normally hard to obtain in reality.

Therefore, it is practically important to design robust decoding schemes that do not require the accurate knowledge of the noise distribution. Without knowing the impulsive noise probability density function, one promising solution is to identify the symbols that are likely to be corrupted by large amplitude noise and ignore (erase) them in decoding as suggested above.

Two examples of such solutions are the region-based erasure marking schemes and the Viterbi's ratio-threshold technique, which can alleviate the problem of metric mismatch. For example, a joint erasure marking and Viterbi decoding algorithm (JEVA) has been proposed for convolutionally encoded systems. It has been shown that by exploiting the code structure in marking erasures, JEVA is able to identify the corrupted symbols more accurately than other conventional separate erasure marking and decoding approaches. For example, JEVA has been demonstrated to be an effective scheme to combat the unknown narrowband interference in Orthogonal Frequency-Division Multiplexing (OFDM) based cognitive radio systems.

However, further improvements in impulsive noise decoder performance are desired while minimizing decoder complexity.

The above-described deficiencies are merely intended to provide an overview of some of the problems encountered in non-Gaussian decoder design, and are not intended to be exhaustive. Other problems with the state of the art may become further apparent upon review of the description of the various non-limiting embodiments of the invention that follows.

### SUMMARY

In consideration of the above-described deficiencies of the state of the art, the invention provides joint erasure marking and list Viterbi algorithm (JELVA), decoder algorithms, methods, and systems that provide robust trellis decoder techniques and that does not require an estimate of the impulsive noise distribution.

To that end, the invention provides techniques to further improve JEVA for systems with an error detecting code. Specifically, JEVA is integrated with the list Viterbi algorithm (LVA) to form the two-dimensional joint erasure marking and list Viterbi algorithm (2D JELVA) and switched JELVA, respectively. By combining the respective strengths of the JEVA and the LVA, the integrated decoding schemes are able to achieve significant performance gains over JEVA and achieve a wide range of performance-complexity-delay tradeoffs, according to system design considerations.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the invention in a simplified form as a prelude to the more detailed description that follows.

### BRIEF DESCRIPTION OF THE DRAWINGS

The joint erasure marking and list Viterbi algorithm decoding techniques, systems, and methods are further described with reference to the accompanying drawings in which:

FIG. 1 illustrates an overview of a wireless communication environment suitable for incorporation of embodiments of the present invention;

FIG. 2 illustrates an exemplary non-limiting block diagram of a system suitable for practicing embodiments of the present invention;

FIG. 3 illustrates an exemplary non-limiting block diagram of a Bit-Interleaved Coded Modulation (BICM) system suitable for incorporation of embodiments of the present invention;

FIG. 4 illustrates the formation of an exemplary product trellis with two erasures from the bit trellis for a rate-½ convolutional code according to an embodiment of the invention;

FIG. 5 illustrates an exemplary non-limiting block diagram of a 2D JELVA decoding method according to various embodiments of the invention;

FIG. 6 illustrates an exemplary non-limiting block diagram of a switched JELVA decoding method according to various embodiments of the invention;

FIG. 7 illustrates an exemplary non-limiting block diagram of a sequential iterative decoding system suitable for practicing embodiments of the present invention;

FIG. 8 illustrates an exemplary non-limiting block diagram of a sequential iterative decoding scheme applied to the switched JELVA decoding method;

FIG. 9 illustrates an exemplary non-limiting flowchart of a 2D JELVA algorithm according to various embodiments of the invention;

FIG. 10 illustrates an exemplary non-limiting flowchart of a switched JELVA algorithm according to various embodiments of the invention;

FIG. 11 depicts the FER performance of the (J×L) 2D JELVA with various values of J and L and the switched JELVA with effective list sizes of 8 and 16, respectively, at Signal-to-Impulse-power Ratio SIR=3 dB , according to a particular embodiments of the present invention;

FIG. 12 depicts the LVA, JEVA and the switched JELVA with various effective list size up to 16 at Signal-to-Noise Ratio SNR=17 dB according to particular embodiments of the invention;

FIG. 13 depicts the effect of the threshold η on the performance of the switched JELVA according to particular embodiments of the invention;

FIG. 14 is a block diagram representing an exemplary non-limiting networked environment in which the present invention may be implemented;

FIG. 15 is a block diagram representing an exemplary non-limiting computing system or operating environment in which the present invention may be implemented; and

FIG. 16 illustrates an overview of a network environment suitable for service by embodiments of the invention.

### DETAILED DESCRIPTION

### Overview

Simplified overviews are provided in the present section to help enable a basic or general understanding of various aspects of exemplary, non-limiting embodiments that follow in the more detailed description and the accompanying drawings. This overview section is not intended, however, to be considered extensive or exhaustive. Instead, the sole purpose of the following embodiment overviews is to present some concepts related to some exemplary non-limiting embodiments of the invention in a simplified form as a prelude to the more detailed description of these and various other embodiments of the invention that follow. It is understood that various modifications may be made by one skilled in the relevant art without departing from the scope of the disclosed invention. Accordingly, it is the intent to include within the scope of the invention those modifications, substitutions, and variations as may come to those skilled in the art based on the teachings herein.

In consideration of the above described limitations of conventional decoding schemes for non-Gaussian noise channels, in accordance with exemplary non-limiting embodiments, the invention provides joint erasure marking and list Viterbi algorithm (JELVA), decoder algorithms, methods, and systems that provide robust trellis decoder techniques and that does not require an estimate of the noise distribution (e.g., by impulsive noise in the time domain for a single-carrier modulation communication signal, by narrowband interference in the frequency domain for a multi-carrier modulation communication signal, the one or more of the plurality of symbols are noise-corrupted, etc.).

To that end, the invention provides techniques to further improve JEVA for systems with an error detecting code. Specifically, JEVA is integrated with the list Viterbi algorithm (LVA) to form the two-dimensional joint erasure marking and list Viterbi algorithm (2D JELVA) and switched JELVA. By combining the respective strengths of the JEVA and the LVA, the integrated decoding schemes are able to achieve significant performance gains over JEVA and achieve a wide range of performance-complexity-delay tradeoffs, according to system design considerations.

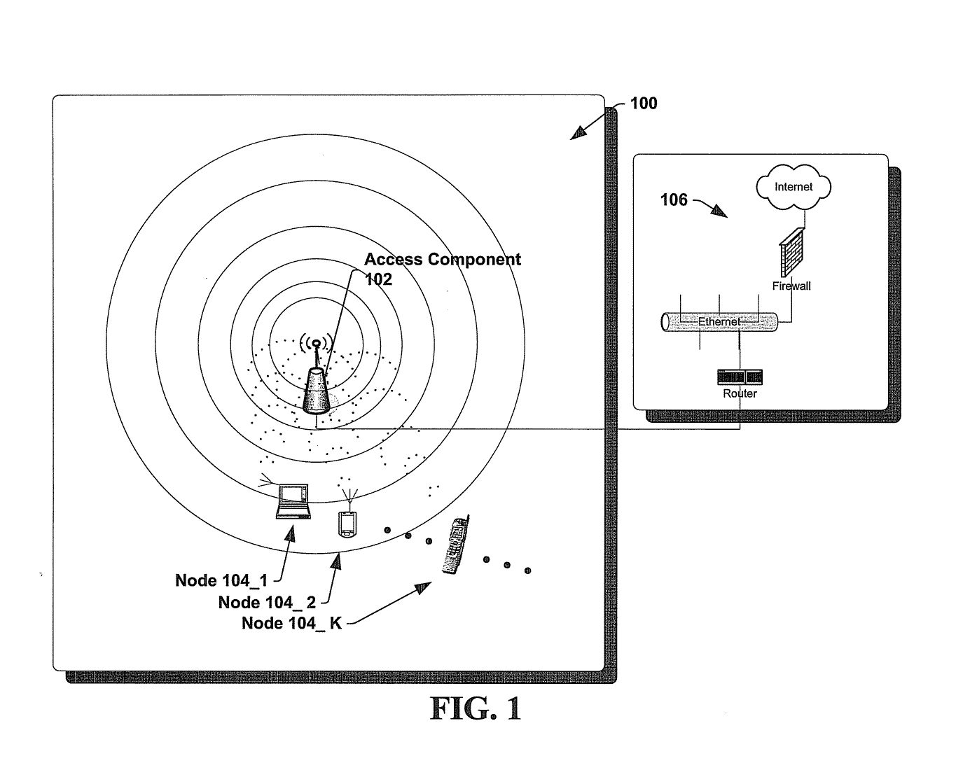

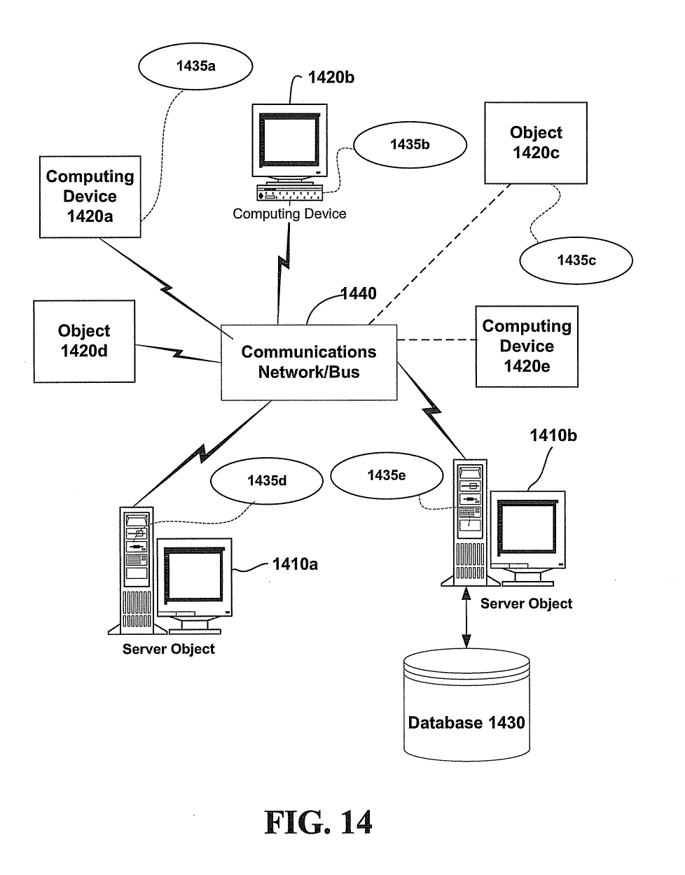

FIG. 1 is an exemplary, non-limiting block diagram generally illustrating a wireless communication environment 100 suitable for incorporation of embodiments of the invention. Wireless communication environment 100 contains a number of nodes 104 operable to communicate with a wireless access component 102 over a wireless communication medium and according to an agreed protocol. As described in further detail below, such nodes and access components typically contain a receiver and transmitter configured to receive and transmit communications signals from and to other nodes or access components. FIG. 1. illustrates that there can be any arbitrary integral number of nodes, and it can be appreciated that due to variations in transmission path, node characteristics, scattering environment, and other variables, the subject invention is well-suited for use in such a diverse environment. Optionally, the access component 102 may be accompanied by one or more additional access components and may be connected to other suitable networks and or wireless communication systems as described below with respect to FIGS. 14-16.

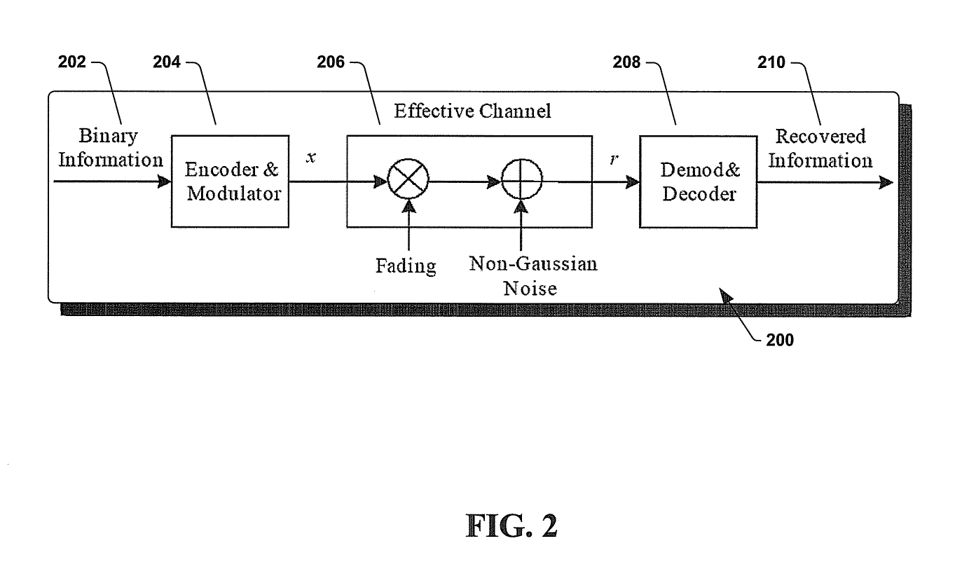

FIG. 2 illustrates an exemplary non-limiting block diagram of a system 200 suitable for practicing embodiments of the present invention. Binary information sequences 202 are encoded and modulated at the transmitter side 204. The data sequence is passed through the channel 206 and is demodulated and decoded 208 at the receiver side. It is noted that the effective channel includes all possible processing and noise sources occurring between the modulator and the demodulator.

In most of the works on communications, the transmitted data is assumed to be corrupted by Gaussian noise. The Gaussian model is successful in modeling some important random phenomena such as thermal noise and leads to tractable equations. However, in many realistic communication environments, the transmission is additionally disturbed by high amplitude interference so that the overall noise statistics deviate from the Gaussian distribution (including for example, naturally occurring and man-made impulsive noise in wireless communication environments, impulsive noise in wired communication channels, and non-Gaussian interference due to the sharing of communication medium).

For example, impulsive noise has been observed in both outdoor and indoor radio communication environments through extensive measurements. The source of the impulsive noise may be naturally occurring or man-made. Naturally occurring radio frequency sources include atmospheric, solar, and cosmic noise sources. Below 20 MHz, atmospheric noise predominates over other natural sources. From 1 MHz to 10 GHz, the radio noise sources include solar-flare radio-noise radiation, lunar emission and galactic noise. Impulsive noise from automobiles is generated mainly by the ignition system. Impulses arise from the discharge of the coaxial capacitor of the spark plug. The radiated noise exists in the frequency band from 30 MHz up to 7 GHz. In urban areas, the automotive ignition noise is a significant impulsive noise sources. Noise radiated from electric-power generation, transformation, and transport facilities is another important impulsive radio noise source which occurs within the spectral range extending from the fundamental generation frequency (usually 50 Hz) into the ultra high frequency band. Gap-discharge and corona-discharge are the major sources of radio interference in the electric-power facilities. The noise in the power-distribution line may be comparable or greater than the automobile ignition noise in rural areas. Impulsive noise measurements for indoor environments have been conducted for the frequency bands from 900 MHz up to 4 GHz, which are currently used or are considered for future indoor wireless systems. The principle sources of radio impulsive noise sources in indoor environments are the devices with electromechanical switches including electric motors in elevators, refrigeration unites, copy machines, printers, etc. The peak amplitude of the impulsive noise can be as large as 40 dB higher relative to the measured thermal noise. The average pulse duration is in the order of a few hundred nanoseconds.

In digital subscriber line (DSL) loops, the impulsive noise is one of the most damaging impairments. In unshielded twisted pairs, impulsive noise can be generated by signaling circuits, transmission and switching gear, electrostatic discharges, lightning surges and so forth. It has been reported that the typical impulsive noise occurs about 1 to 5 times per minute and has a time duration ranging from 30 μs to 150 μs and can exceed 500 μs.

Power lines form a potentially convenient and inexpensive communication medium for their omnipresence even in rural or remote areas where telephone, cable and wireless networks are difficult to cover. Impulsive noise exists in power line communication (PLC) channels and can be categorized into two classes: synchronous and asynchronous impulsive noise. Asynchronous impulsive noise is mainly caused by switching transients that occur all over a power supply network at irregular intervals. Like in DSL loops, the duration of the impulsive noise frequently exceeds the symbol interval. The impulse width is in the order of 100 μs and the interval time is around 100 ms. Normally, the disturbance ratio is less than 1%.

The explosive growth of wireless services in recent years illustrates the huge and growing demand for spectrum-based communications. Due to the limited frequency resources, the frequency is reused by various users and various communication applications. The users that share the same propagation medium become interference sources for other simultaneous users. Assuming the interfering users are spatially Poisson distributed and under a power-law propagation loss function, it has been shown that the co-channel interference can be modeled as an a —stable distribution. For example, IEEE 802.11g Wireless Local Area Network (WLAN) systems operates in the same frequency band as Bluetooth systems, which are narrowband frequency-hopping systems. For a typical 200 μs long WLAN packet, the probability of collision with a Bluetooth packet is more than 20%.

Multiple access interference in a Code-Division-Multiple-Access (CDMA) system is a wide-band, non-stationary stochastic process. The randomness of the interference comes mainly from three stochastic sources (e.g., radio propagation, traffic variation, and mobile distribution). It has been shown that such interference is bursty in nature. The variation in the interference power is relatively large for a small number of users and for a shorter inter-arrival time for packet data calls. The integration of data communication services also increases the variation relative to voice-only communication systems. Moreover, it has been shown that with power control, overall multiple-access interference has “peakings” which come mostly from distant users. This can occur due to perfect tracking of deep fades by only a few users, or even a single dominant user, thus driving the overall interference statistics away from the central limit theorem. These interference distributions are not well studied. It is therefore not straightforward to find a suitable mathematical model for the noise in such wireless communication systems. Similarly, in frequency-hopped (FH) systems, a number of symbols are transmitted during the same dwell interval through a hopped frequency band. Once the transmitted symbols are hopped into the fraction of band where the partial band jammer for other users are present, the symbols become corrupted. Due to the time-varying nature of the impulsive noise, it is difficult to estimate its distribution accurately. In addition, the difficulty in selecting an appropriate noise model presents an additional problem. Without taking the impulsive noise PDF into account, this can result in metric mismatch in the decoder, and can seriously degrade decoder performance. Moreover, the difficulty in selecting an appropriate noise model to presents an additional problem. Consequently, it is important to design robust decoding schemes that do not require the accurate knowledge of the noise distribution.

To further improve the performance of JEVA for systems with a powerful error detecting code, according to various non-limiting embodiments the invention integrates JEVA with the list Viterbi algorithm (LVA) to provide joint erasure marking and list Viterbi algorithm (JELVA). Both JEVA and LVA are list output extensions of the VA in the sense that they both generalize the Viterbi algorithm (VA) to find a list of candidate codewords. While LVA finds the most likely L codewords (without marking any erasure), JEVA finds for e=0,1, . . . , J−1, the most likely codeword with c erasures marked.

According to further non-limiting embodiments, by integrating LVA with JEVA, the two-dimensional (2D) JELVA finds for c=0,1, . . . , J−1, the most likely L codewords with c erasures marked. As a result, the 2D JELVA provides two degrees of freedom in marking erasures and decoding the correct codeword. Since the performance of the 2D JELVA depends on pre-set parameters, including J and L, it may not be adaptive to the changing noise condition.

Accordingly, in further non-limiting embodiments of the invention a switched JELVA, which is able to switch from the JEVA mode to the LVA mode automatically, is provided. By combining the respective strengths of JEVA and LVA in two dynamically switched decoding stages, the switched JELVA provides an adaptive alternative under the worst case decoding delay constraint.

In further non-limiting embodiments 2D JELVA can be implemented using either a parallel or serial LVA scheme according to system design considerations.

In further non-limiting embodiments of the invention, 2D JELVA and switched JELVA can be implemented in an iterative fashion to exploit bit to symbol association to simplify the decoding schemes

### System Model

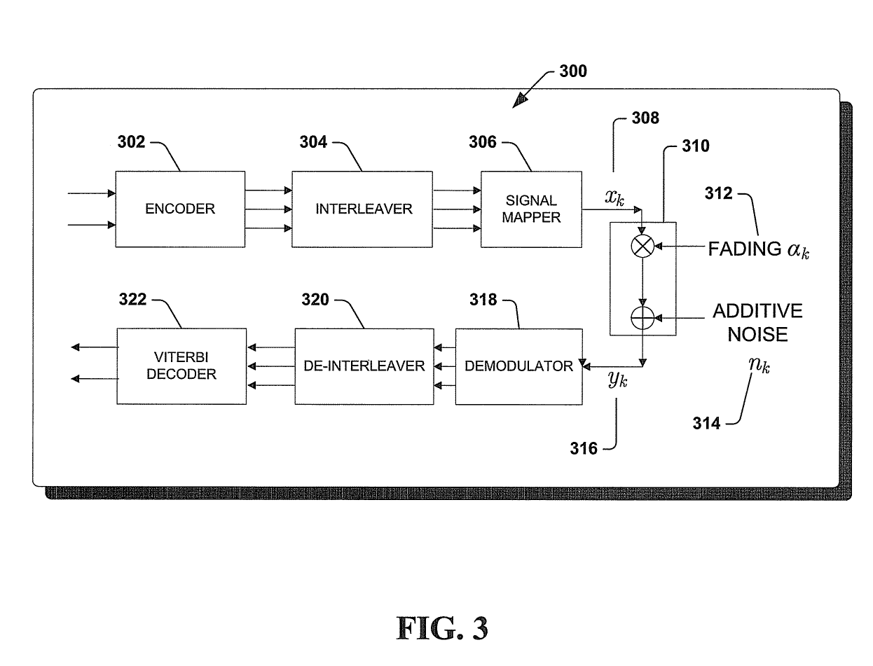

FIG. 3 illustrates an exemplary non-limiting block diagram of a Bit-Interleaved Coded Modulation (BICM) system 300 suitable for incorporation of embodiments of the present invention. In BICM, the coding and modulation are distinct operations as illustrated in FIG. 3. First, a code is applied to the input data stream in encoder 302. The coded bits (codewords) are then passed through an interleaver 304, and encoded using a mapping 306 from codewords to constellation elements 308 (e.g., 16 QAM with Gray or partition labeling, etc.). After passing through the channel 310, the output 316 is demodulated 318 and de-interleaved 320. Finally, the codeword estimates are decoded 322 (e.g., using a decoder or an iterative decoder). As an example, in coded OFDM systems, the transmitter convolutionally encodes and bit-wise interleaves the information sequence. Such an encoder has been widely adopted in many OFDM-based standards like IEEE 802.11 and 802.16.

The term BICM arises from the fact that it is the coded bits that are interleaved prior to modulation. This contrasts with the “common” interleaving practice, where the encoded symbols themselves are interleaved to obtain independent channel instantiations (fades) to increase the diversity order.

At the transmitter side (302, 304, 306), the information sequence is convolutionally encoded 302 and bit-wise interleaved 304. Every m-tuple

[symbol]

, . . . , [symbol]
, . . . , [symbol]
^{m} of the interleaved binary codeword is mapped to a symbol chosen from an M-ary (M=2^{m}) signal set based on a mapping function μ 308. Letting xₖ 308 represent the kth transmitted symbol, the received signal yₖ 316 can be represented as:

yₖ=aₖ·xₖ+nₖ Eqn. 1

where aₖ is the complex Rayleigh fading factor and nₖ is the additive channel noise. The channel noise is assumed to be a composition of the background Gaussian noise and the randomly arrived impulses with an unknown distribution.

Although the invention provides robust decoding algorithms suitable for combating a wide rage of generic impulse noise with unknown distributions, the Bernoulli-Gaussian impulsive noise model is assumed for the purpose of evaluating the algorithms. Accordingly, such noise models should not be understood to be the only suitable environment for implementing the present invention. For example, additional environments include, but are not limited to, single-carrier modulation communication signals corrupted by impulsive noise in the time domain, multi-carrier modulation communication signals corrupted by narrowband interference in the frequency domain, and the like.

Mathematically, the discrete-time Bernoulli-Gaussian noise can be represented as:

nₖ=wₖ+bₖ·gₖ Eqn. 2

where bₖ is the Bernoulli process with parameter p, wₖ, and gₖ are the additive zero mean Gaussian noise with variance σ_{G}² and σ_{I}² (σ_{I}²>>σ_{G}²), respectively.

### Joint Erasure Marking and ListViterbi Algorithm

Referring back to FIG. 3, the conventional BICM decoding scheme contains a demodulator 318, a deinterleaver 320 and a Viterbi decoder 322. Assuming the noise is Gaussian, the demodulator 318 calculates the metric for all the bits [symbol] =(b=0, 1; i=1, 2, . . . , m) that correspond to the same symbol xₖ as:

$$λ ( {{c}^{̑}}^{i} = b ) = {min}_{{x}_{k} ∈ {χ}_{b}^{i}} {\vert {y}_{k} - {α}_{k} {x}_{k} \vert}^{2} \qquad Eqn . 3$$

where X_{b}ⁱ={μ([ĉ⁻¹, . . . , ĉⁱ, . . . , ĉ^{m}]) |ĉⁱ=b} represents the signal subset with ĉⁱ being equal b. After deinterleaving 320, the decoding metric for each codeword C=[c¹, . . . , c¹, . . . , c^{N}] can be obtained by summing up the corresponding bit metrics, e.g.,

$${ψ}_{0} ( C ) = {\sum }_{i = 1}^{N} λ ( {c}^{i} ) \qquad Eqn . 4$$

In the presence of impulse noise, the metric in Eqn. 3 gives a mismatched metric for the impulse-corrupted symbols. Without knowing the impulse distribution, one simple yet effective way to mitigate this problem is to treat the impulse-corrupted symbols as erasures. The problem is then how to mark the erasures accurately.

According to various non-limiting embodiments of the invention, JELVA builds on the idea of joint erasure marking and Viterbi algorithm (JEVA) to exploit the code structure for erasure marking as well as decoding, and is able to mark erasures more accurately than the conventional separate erasure marking and decoding schemes. A straightforward implementation of JEVA involves two steps. First, to allow a maximum of J−1 erasures, for e=0,1, . . . , J−1, find the most likely codeword with e erasures. This results in J not necessarily distinct candidate codewords. In the second step, the appropriate number of erasures is determined, and the corresponding codeword is selected from the J candidates as the output codeword. This step can help ensure the erasure of all impulse-corrupted symbols and that substantially no additional symbols are erased unnecessarily.

Mathematically, the decoding metric for codeword C with e erasures is defined as:

$${ψ}_{e} ( C ) = {min}_{Ω} {\sum }_{i = 1 , i ∉ Ω}^{N} λ ( {c}^{i} ) \qquad Eqn . 5$$

where the minimization is taken over all possible sets Ω of e bit positions in the codeword. The most likely codeword \tilde{C} with e erasures is the one that minimizes the metric, e.g,

$$\tilde{C} = {argmin}_{C} {ψ}_{e} ( C ) \qquad Eqn . 6$$

where the minimization is taken over the set of all valid codewords.

### Two-Dimensional JELVA (2D JELVA)

According to various non-limiting embodiments, the invention further improves the performance of JEVA by integrating it with the list Viterbi algorithm (LVA). The LVA generalizes the VA by finding the most likely L codewords with L>1. With an outer error detecting code, the LVA is able to (partially) exploit the error correction capability of the code and outperforms the maximum likelihood decoder that does not take advantages of the error detecting code. When integrated with JEVA, the most likely L codewords can be obtained for every fixed number of erasures. The l th l=1, 2, . . . , L most likely codeword \tilde{C}^{(l)} with e erasures can be expressed as:

$${\tilde{C}}^{( l )} = {{argmin}_{C}}^{( l )} = \{ {min}_{Ω} {\sum }_{i = 1 , i ∉ Ω}^{N} λ ( {c}^{i} ) \} \qquad Eqn . 7$$

where min^{(l)} denotes the operation of taking the l th minimum. With the same number of erasures, the erasure positions need not be the same for the most likely L codewords. For example, finding the best L codewords for a specified number of erasures provides an additional degree of freedom to mark erasures and decode the correct codeword. Thus, various implementations according to this family of embodiments are termed two-dimensional (2D) joint erasure marking and list Viterbi algorithm (JELVA). Similar to LVA, these candidate codewords can then be selected by the outer error detecting code.

Suppose that the 2D JELVA is extended from the JEVA with an effective list size of J corresponding to a maximum of J−1 erasures. The 2D JELVA that outputs the most likely L codewords for each number of erasures ranging from 0 to J−1 is denoted as the (J×L) 2D JELVA, where J and L indicate the respectively effective list sizes in each dimension and the value of JL is the maximum effective list size of the 2D JELVA.

According to various non-limiting embodiments, the invention can determine the candidate codewords in Eqn. 7 by locating shortest paths in a product trellis. To build the product trellis, the invention extends the code trellis into a bit trellis by inserting intermediate states in each branch such that each branch in the bit trellis corresponds to a single code bit. Then each state can be extended s in the bit trellis into multiple states in the product trellis represented by the pairs (s, e) e=0,1, . . . , J−1 with e counting the number of bits marked as erasures from the beginning state to the current state. For ease of reference, s and e are called the code state and erasure substate, respectively. Because of this state expansion, each permissible transition from state s′ to s in the bit trellis can be expanded to a plurality of transitions between the resultant states in the product trellis. Specifically, the two states (s′, e′) and (s, e) are connected iff e′=e or e=e−1.

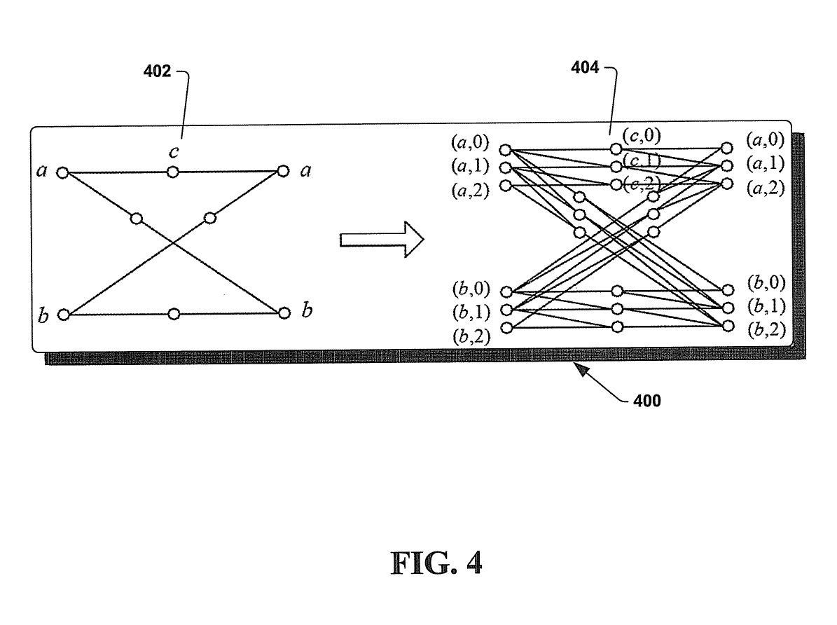

FIG. 4 illustrates the formation of an exemplary product trellis with two erasures from the bit trellis for a rate-½ convolutional code according to an embodiment of the invention, in which a simple example of the product trellis with J=3 expanded from the bit trellis is shown. The branch metric of the transition from (s′, e) to (s, e) is the corresponding bit metric given by Eqn. 3. The branch metric of the transition from (s′, e−1) to (s, e) is zero, meaning that the corresponding bit is erased. Thus, the erasure marking operations are incorporated in the described product trellis representation. Each complete path ending at a state with the erasure substate e in the product trellis represents a unique combination of a valid codeword and e erasure positions.

With the product trellis, according to one embodiment of the invention, the parallel LVA is applied to find the shortest L paths in parallel 2D JELVA. For example, at each state (s, e) in the product trellis, the parallel LVA keeps all of the best L incoming partial paths as the surviving paths and allows each of these surviving paths to be extended as incoming paths to the next state. In addition, parallel LVA can operate on the trellis, section by section, in a manner similar to the traditional VA. In the last section of the product trellis, there are J ending states corresponding to the terminating code state with 0 to J−1 erasures, respectively. Finally, the shortest L paths for each number of erasures can be obtained in parallel as the L surviving paths of the ending code state with the corresponding erasure substate. For a rate-k′/n′ ′-state convolutional code, the JEVA with a maximum of J−1 erasures requires 2^{k′}n′Jζ additions and (2^{k′}n′+2^{k′}−1)Jζ−2^{k′}n′ζ comparisons for each section of the code trellis. The complexity of the parallel 2D JELVA with a list size of L is L times that of the JEVA.

According to a further embodiment of the invention, the list of candidate codewords can also be obtained sequentially. The serial implementation advantageously saves the computational complexity, but at the cost of increased decoding delay. To find the best L codewords without erasure, only the first layer of the product trellis is involved, where the ith (1≦i≦J) layer refers to the trellis states with all erasure substates being i−1. Therefore, these codewords can be obtained prior to the codewords with one additional erasure. Moreover, these L codewords can be obtained sequentially using the serial LVA, which is known to be much simpler than the parallel LVA. The serial LVA incrementally finds the lth best path by exploiting the fact that the lth best path must be among the competing paths directly diverging from the best to the (l−1) th best paths. To find the lth best path, it is sufficient to find the locally second best path merging with the (l−1)th best path at all time instants. To efficiently find the locally second best paths, the partial path metric difference at each trellis state can be calculated in advance. After the best L paths with zero erasure are obtained, the state metrics of the first layer can be used to calculate the state metrics of the second layer and to find the best L paths with one erasure. The process can continue until a codeword is found to satisfy the error checking condition or the number of codewords exceeds the limit JL.

The additional computations to find more than one codeword using serial LVA relative to VA includes the calculation of the incoming partial path metric difference at each state of the trellis and the ranking process. As an example, consider a rate-½ ζ-state convolutional code. To calculate the state metrics of the first layer, 5ζ operations, including additions and comparisons, are needed for each section of the code trellis. One more subtraction is needed to get the partial path metric difference. The ranking process introduces about

$$Δ {=}^{Δ} L - 2 + ( L - 1 ) \cdot [ {log}_{2} ( L + 1 ) ]$$

comparisons per code trellis section. To summarize, a total of 6ζ+Δ operations are required for finding the best L codewords without erasure. To find the best L codewords with one erasure, 9ζ, 8ζ, and 2Δ more operations are needed for calculating the state metrics, partial path metric differences and the ranking, respectively.

In general, to find the best L codewords for 0 up to J−1 erasures, 6ζ+Δ+(J−1)(17ζ+2Δ) operations are needed for each section of the code trellis. For a code with a large memory or for a small list size L, the computational complexity of the ranking is negligible and an increment in the value of J has a greater impact on the overall complexity than that in L.

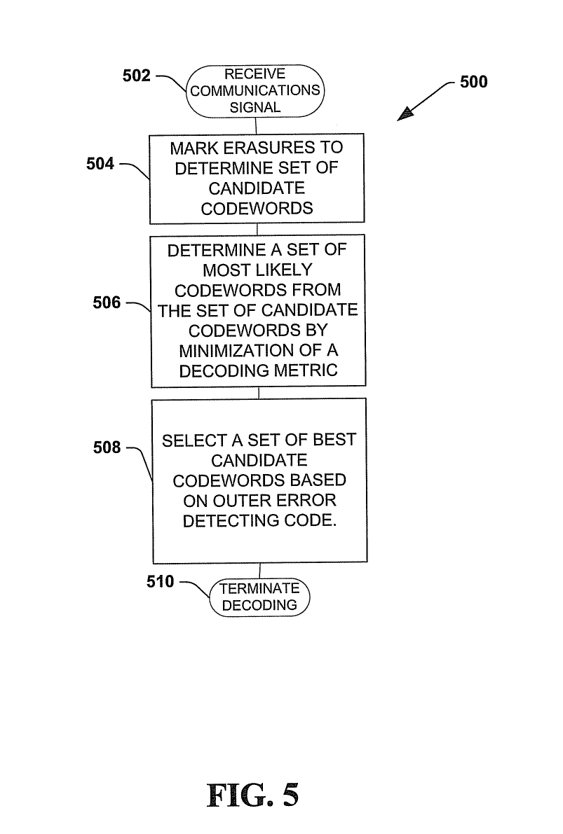

FIG. 5 illustrates an exemplary non-limiting block diagram of a 2D JELVA decoding method according to various embodiments of the invention.

### Switched JELVA

The 2D JELVA always computes all of the best L codewords before it turns to find the best codewords with more erasures. This fixed allocation of computing resource may not be always desirable. With a given effective list size, the earlier the correct codeword appears in the list, the more efficient the decoder is. Intuitively, if the number of erasures marked is insufficient, the achievable performance gain of LVA is very limited because the metrics of the unerased impulse-corrupted symbols are likely to greatly affect the selection of the best path. On the other hand, once all the impulse-corrupted symbols have been erased by JEVA, marking more erasures will not lead to a further performance gain but will result in increased complexity and a worse case for decoding delay.

Based on these revelations, according to further non-limiting embodiments, the invention provides switched JELVA, which can first operate in the JEVA decoding mode and then can dynamically switch to the LVA decoding mode. The decoding process can terminate either when a codeword is found to satisfy the error checking condition, or the number of calculated candidate codewords reaches the pre-set maximum effective list size. By taking the advantages of JEVA and LVA in different decoding stages, the switched JELVA is able to outperform both JEVA and LVA with the same effective list size.

To determine the sufficient number of erasures, according to various non-limiting embodiments, the invention can apply a criterion (e.g., the path metric-difference (PD) criterion). The path metric difference between two successive most likely codewords with e−1 and e erasures can be evaluated for e=1, 2, . . . sequentially. If the path metric difference of the codewords with e−1 and e erasures is less than a pre-set threshold η, then e−1 erasures are determined to be sufficient and the decoder should switch to the LVA decoding mode with e−1 erasures. This criterion can be justified by the fact that after all the impulse-corrupted bits are erased, erasing one more bit will result in a relatively small path metric difference.

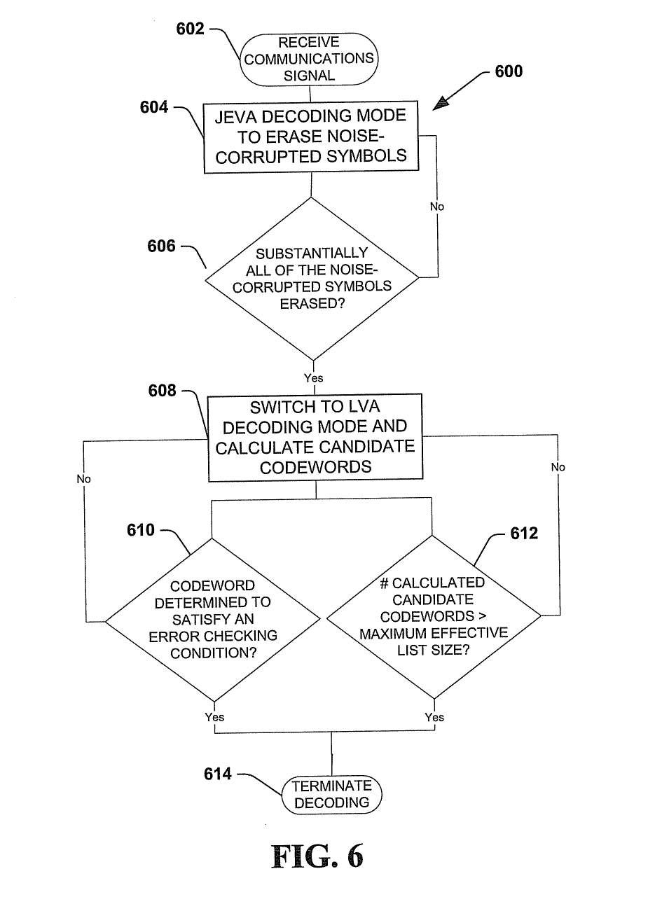

FIG. 6 illustrates an exemplary non-limiting block diagram of a switched JELVA decoding method according to various embodiments of the invention.

### Simplified JELVA Implementation for BICM

For each interference jammed channel symbol, the decoder typically marks m bit erasures to eliminate the effect of the interference. Instead of marking the m bit erasures at the same time, the decoder may mark single erasures at a time and feedback the bit erasure position to the demodulator. Advantageously, according to various non-limiting embodiments, the invention is well suited to exploiting the information of the labeling mapping, to indicate the corresponding channel symbol that contains the marked bit, so that the symbol as a whole can be located and erased.

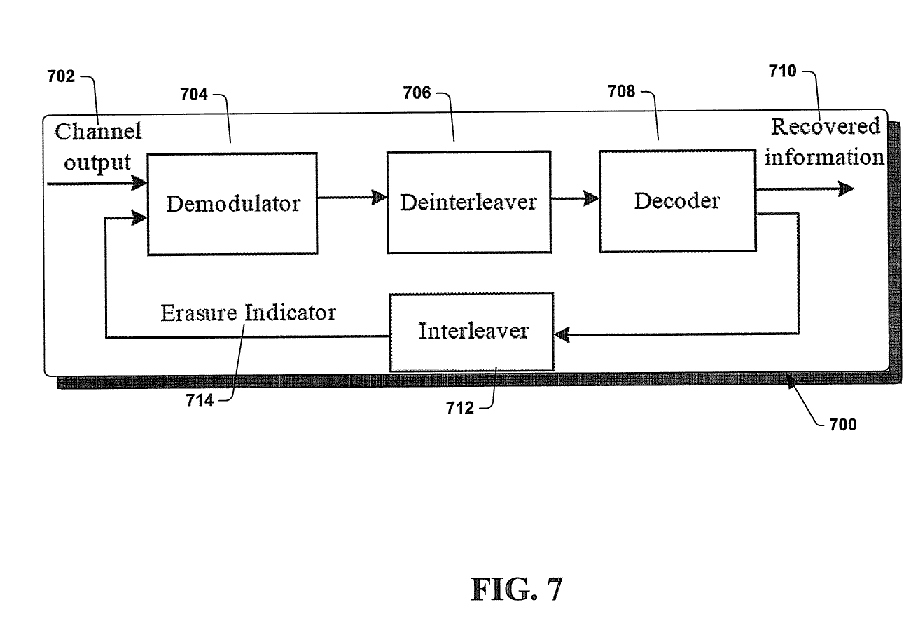

FIG. 7 illustrates an exemplary non-limiting block diagram of a sequential iterative decoding system 700 suitable for practicing embodiments of the present invention. As the block diagram indicates, a decoding scheme can consist of multiple decoding passes.

In such a scheme, during each decoding pass, a decoder 708 can perform single bit erasure, where each decoding pass finds the most likely codeword with one additional bit erasure. Once the sufficiency criterion is satisfied, the decoding can be terminated. For each decoding pass, the demodulator does not need to compute the bit metric again. It only rewrites the bit metrics that correspond to the marked symbol as zeros. It is noted that such a serialized decoding scheme significantly reduces the decoding complexity but requires longer decoding delay. Moreover, the scheme is suboptimal compared with a decoding scheme where all the bit erasures are marked during the same decoding pass. Because bit erasures are marked separately instead of jointly, the sequential decoding is more likely to mark erasures wrongly if the jammed bits are not separated far enough in the codeword.

It is clear that the larger the number of erasures to mark, the more complex the proposed decoders are. For a rate-½ convolutional code, for instance, the computational complexity of JEVA for finding one more codeword with an additional erasure is about 1.8 (=9ζ/5ζ) times that of the VA. For M-ary modulation, each transmitted symbol corresponds to m bits. If one BICM symbol is corrupted by an impulse, the decoder has to mark m bit erasures to eliminate the adverse effect of that impulse. The decoder complexity is therefore higher for a BICM scheme with a higher order modulation, even though the impulsive noise distribution is unchanged. A more efficient approach is to exploit the bit-to-symbol-association and mark symbol erasures based on the bit erasures, similar to the sequential scheme described above.

Specifically, the decoding 708 can performed iteratively and can perform a single bit erasure marking during each decoding iteration based on the single erasure product trellis and can feed back the most recently found bit erasure position of the most likely codeword with one erasure to the demodulator 704. The demodulator 704 can then mark the corresponding symbol as a new erasure (in addition to all of the symbol erasures marked in previous decoding iterations) and can update the bit metric for the next decoding iteration. For each iteration, the computational complexity can be obtained in the same way as discussed for 2D JELVA with J=2.

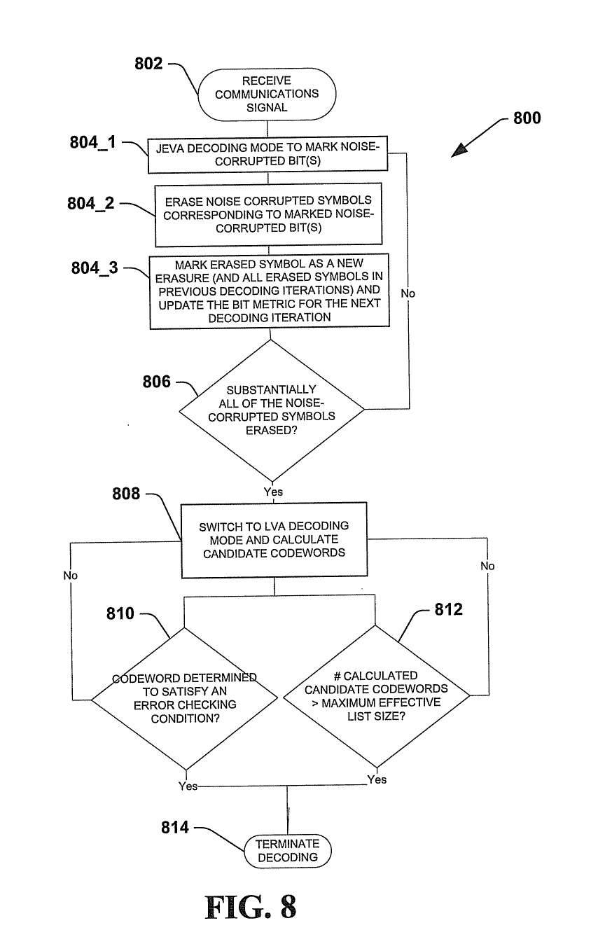

FIG. 8 illustrates an exemplary non-limiting block diagram of a sequential iterative decoding scheme applied to the switched JELVA decoding method.

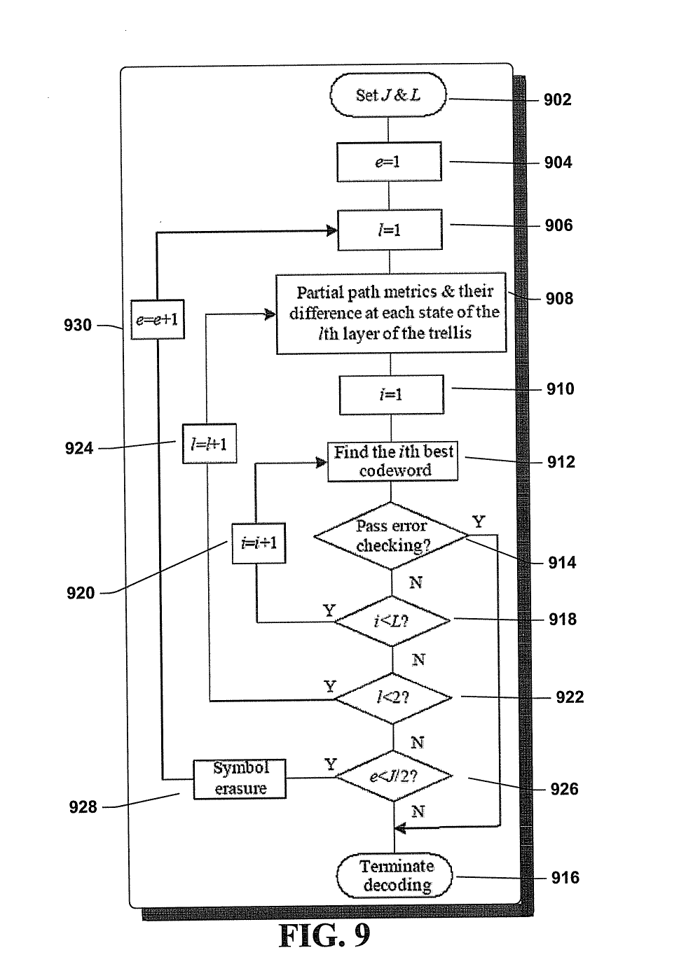

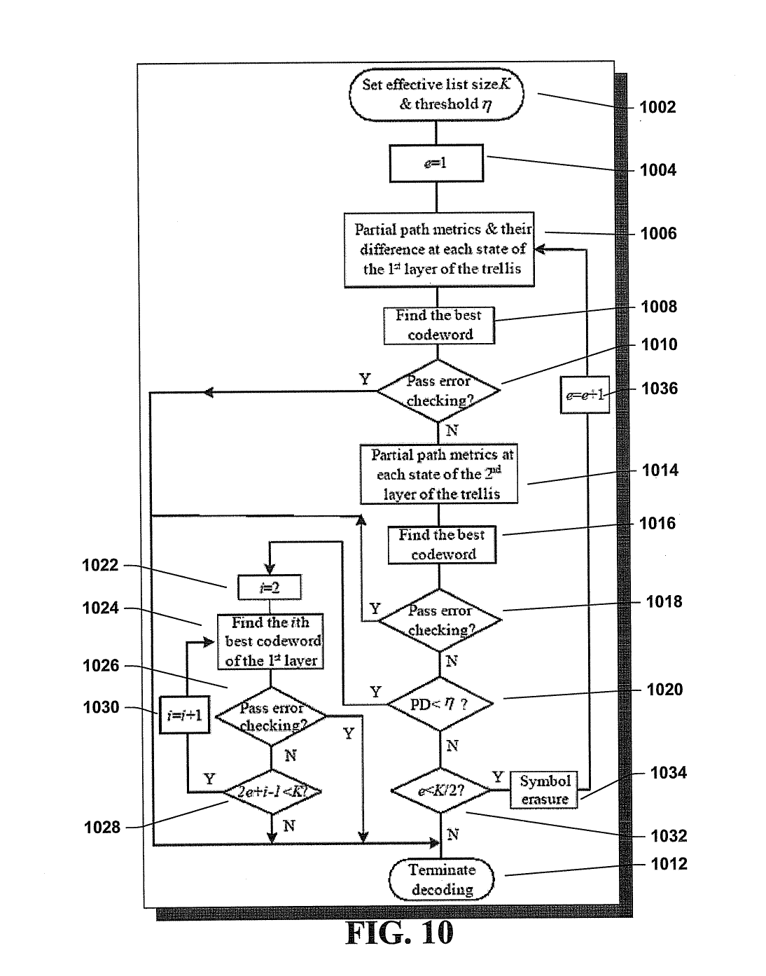

FIG. 9 illustrates an exemplary non-limiting flowchart of a 2D JELVA algorithm according to various embodiments of the invention. FIG. 10 illustrates an exemplary non-limiting flowchart of a switched JELVA algorithm according to various embodiments of the invention.

For either decoding scheme, if the decoding is stopped during the first decoding iteration on the first trellis layer, then the computational complexity is only slightly higher than that of the VA. This is likely to happen at high SNR and low impulse arrival rate. Since the most likely codeword selected by the VA always appears as the first in the candidate codeword list, either algorithm is able to perform at least as good as the VA with a strong enough outer error detecting code.

### 2D and Switched JELVA Results

The decoding schemes of the present invention are evaluated by computer simulation and compared to conventional decoding schemes. Throughout the simulation, the random bit interleaver in the BICM scheme is 1600-bit long. The rate-½ 8-state convolutional code with 16 Quadrature Amplitude Modulation (QAM) is considered. For comparison purposes, only the simplified JELVA implementation for BICM (e.g., that leverages bit-to-symbol-association) for both the 2D JELVA and the switched JELVA are shown. The channel model is an independent Rayleigh fading channel having the Bernoulli-Gaussian noise with p=0.002 and the Signal-to-Impulse-Power Ratio

$$SIR {=}^{Δ} E [ {\vert {x}_{k} \vert}^{2} ] / {σ}_{I}^{2} = 3 dB .$$

Fixing the impulse power facilitates the observation of the decoder's behavior under various impulse to background noise power ratios. The genie error detecting code is assumed for selecting the output codeword. The threshold of the path-metric-difference criterion is selected to be η=24σ_{G}² if not otherwise specified.

In the simulation, it is also assumed that the demodulator performs a simple erasure marking scheme preceding all the decoding schemes under consideration, including the VA, LVA, JEVA and JELVA. Specifically, the demodulator erases the channel symbol xₖ if the metric of any one of its corresponding bit

$${c}^{i} , λ ( {c}^{i} ) = {min}_{{x}_{k} ∈ {χ}_{b}^{i}} {\vert {y}_{k} - {α}_{k} {x}_{k} \vert}^{2}$$

is larger than a threshold which is selected to be identical to the threshold η of the path-metric-difference criterion. This separate erasure marker advantageously helps to erase those easy-to-detect impulse-corrupted symbols and is a simple way to improve the robustness of the conventional VA and LVA against impulsive noise.

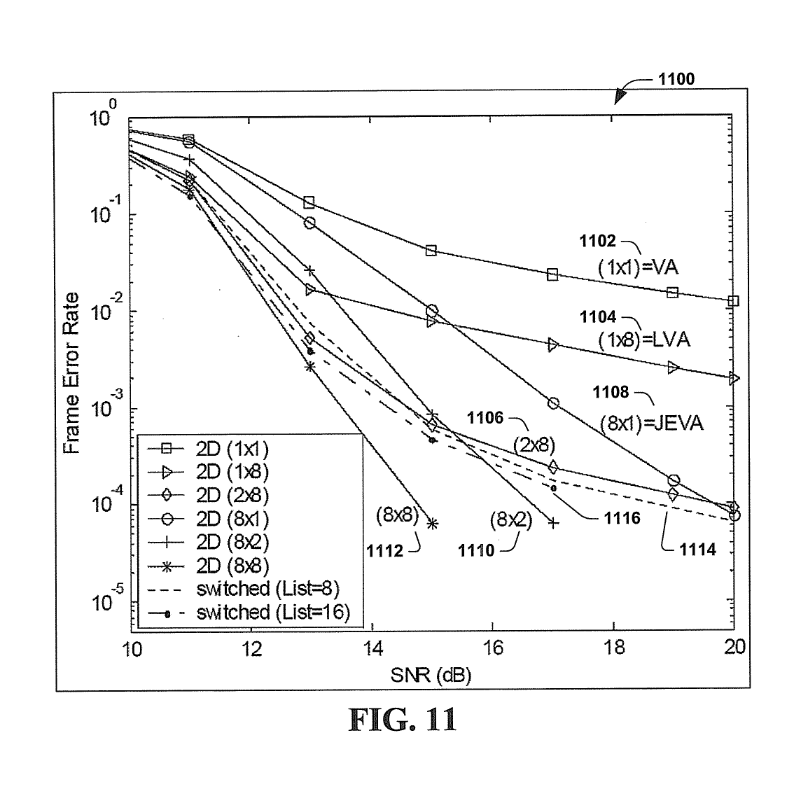

FIG. 11 depicts the FER performance of the (J×L) 2D JELVA with various values of J and L and the switched JELVA with effective list sizes of 8 and 16, respectively, at Signal-to-Impulse-power Ratio SIR=3 dB , according to a particular embodiments of the present invention. In FIG. 11, the frame error rate (FER) performance is plotted against various signal-to-background-noise-power ratio

$$SNR {=}^{Δ} E [ {\vert {x}_{k} \vert}^{2} ] / {σ}_{G}^{2} = 3 dB .$$

The (J×L) 2D JELVA with various parameters are plotted as solid curves in the figure. Due to metric mismatch, the VA and LVA, which are designed for Gaussian noise, exhibit error floor at high SNR where the decoder performance is dominated by the impulses. With one erasure, the (2×8) 2D JELVA greatly outperforms the LVA with a much lower error floor. With a sufficient number of erasures, the (8×1) 2D JELVA (i.e. JEVA) achieves a better performance at high SNR compared with the (2×8) 2D JELVA. By increasing the list size L from 1 to 2, a performance gain of about 3 dB can be achieved at FER=10⁻⁴ . Further increasing L to 8, the (8×8) 2D JELVA achieves an additional 2 dB gain compared with the (8×2) 2D JELVA. Moreover, by comparing the (1×8) with the (8×1) 2D JELVA and the (2×8) with the (8×2) 2D JELVA, it can be seen that under the worst case decoding delay constraint, different values of J and L should be used for different channel conditions to achieve a better FER performance. For the ease of comparison, it is assumed that finding each candidate codeword induces the same decoding delay, so that the (m×n) and (n×m) 2D JELVA have the same worst case decoding delay.

In this figure, the switched JELVA with effective list sizes of 8 and 16 are plotted as the dashed curves. By comparing the performance of LVA, JEVA and the switched JELVA with the same list size of 8, it can be seen that while LVA and JEVA are superior to the other at different SNR, the switched JELVA performs better than both for the whole range of SNR under consideration. When the SNR is low, the impulsive noise power is comparable to the background Gaussian noise power and, thus, the effect of the impulses is not as serious as that at a high SNR. Under this situation, the LVA provides a larger performance gain than the JEVA. As the SNR becomes higher, the advantage of JEVA over LVA becomes larger. This result shows that the switched JELVA is able to successfully adapt to the channel condition and vary the decoding strategy. Its performance improvement over the JEVA vanishes at high SNR where the impulses dominate and the additional coding gain of LVA becomes marginal. The average computational complexity of JEVA and the switched JELVA respectively are about 1.28 and 1.25 times that of the VA at SNR=17 dB. This indicates that the switched JELVA outperforms JEVA with an even lower computational complexity under the same worst case decoding delay constraint. With a doubled maximum effective list size of 16, which results in increased worst case decoding delay, the performance of the switched JELVA is only marginally improved. The performance gain at the LVA stage depends on the accuracy of the erasure marking during the JEVA stage. The erroneous erasures limit the performance gain of LVA even with a large list size.

The (2×8) 2D JELVA performs close to the switched JELVA in FIG. 11 indicating that the PD criterion determines a single erasure to be sufficient in most cases. This is due to the low impulse arrival rate of the simulation environment. For impulse intensive channels, however, the switched JELVA is able to mark more erasures and is expected to outperform the (2×8) 2D JELVA. Under the worst delay constraint, the 2D JELVA with improperly selected parameters may perform worse than the switched JELVA as can be seen by comparing the (8×2) 2D JELVA with the switched JELVA at SNR<15 dB .At SNR=13 dB, the average complexity of the (8×2) 2D JELVA and the switched JELVA are about 1.69 and 1.25 times that of the VA, respectively. For example, the (8×2) 2D JELVA performs worse than the switched JELVA at SNR=13 dB in spite of an even higher complexity and doubled worst case delay. As the performance of the 2D JELVA is dependent on the parameters used, the switched JELVA, on the other hand, is more adaptive to different channel conditions. Therefore, depending on the required constraints on the error rate performance, decoding complexity and delay of the targeted application, the 2D JELVA and the switched JELVA can be adopted accordingly to offer various performance-complexity-delay trade-offs. Moreover, the parallel implementation can be considered to provide further complexity-delay trade-offs.

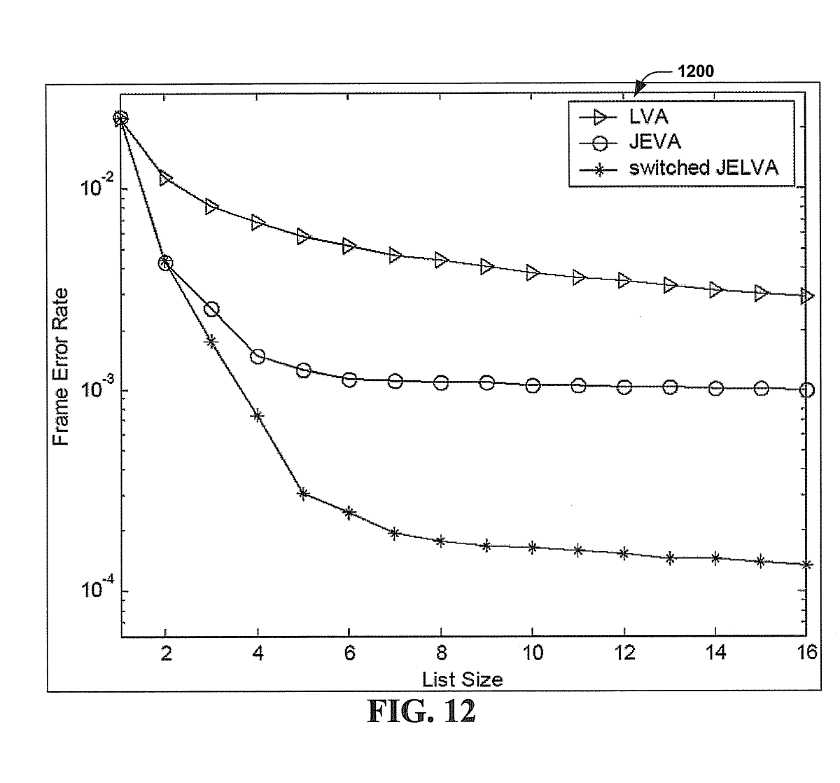

FIG. 12 depicts the LVA, JEVA and the switched JELVA with various effective list size up to 16 at Signal-to-Noise Ratio SNR=17 dB according to particular embodiments of the invention. It can be seen that as the list size gets larger, the performance of LVA improves rather gradually due to the metric mismatch problem. The JEVA, on the other hand, finds the most likely codewords by erasing the impulse-corrupted symbols and therefore performs better. It is noted that most impulses are eliminated after erasing three symbols and marking more erasures will not lead to further improvement. The switched JELVA takes advantages of the LVA and JEVA and performs significantly better than both with the same number of candidate codewords. In addition, it allows useful performance improvement up to a larger effective list size of eight.

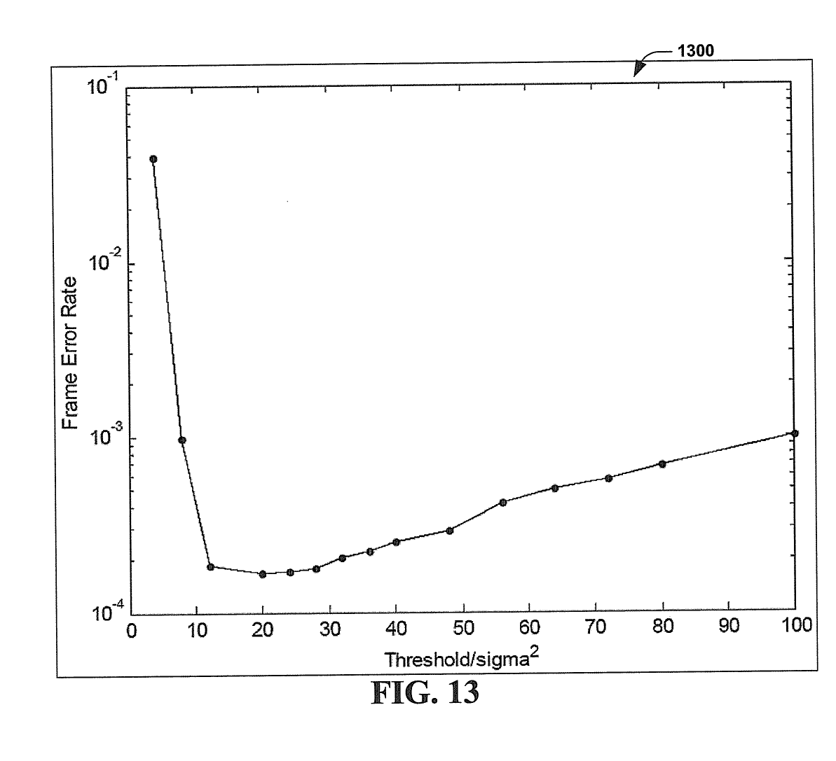

FIG. 13 depicts the effect of the threshold η (path-metric difference criterion) on the performance of the switched JELVA with an effective list size of eight at SNR=17 dB, according to particular embodiments of the invention. This figure indicates that the performance is comparatively insensitive to the threshold selection.

The results show that the invention improves the performance of the joint erasure marking and Viterbi algorithm (JEVA) by integrating the list Viterbi algorithm (LVA). The direct combination of the two algorithms is to compute more than one best codewords for each number of erasures. This combination allows two degrees of freedom in marking erasures and significantly improves the error rate performance. The invention further provides an adaptive decoding scheme which switches from JEVA to LVA based on the path-metric-difference criterion. The switched decoding scheme is able to adapt to different channel conditions and outperform both the JEVA and the LVA with the same effective list size.

### Exemplary Computer Networks and Environments

One of ordinary skill in the art can appreciate that the invention can be implemented in connection with any computer or other client or server device, which can be deployed as part of a communications system, a computer network, or in a distributed computing environment, connected to any kind of data store. In this regard, the present invention pertains to any computer system or environment having any number of memory or storage units, and any number of applications and processes occurring across any number of storage units or volumes, which may be used in connection with communication systems using the decoder techniques, systems, and methods in accordance with the present invention. The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the communication systems using the decoder techniques, systems, and methods of the invention.

FIG. 14 provides a schematic diagram of an exemplary networked or distributed computing environment. The distributed computing environment comprises computing objects 1410a, 1410b, etc. and computing objects or devices 1420a, 1420b, 1420c, 1420d, 1420e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1440. This network may itself comprise other computing objects and computing devices that provide services to the system of FIG. 14, and may itself represent multiple interconnected networks. In accordance with an aspect of the invention, each object 1410a, 1410b, etc. or 1420a, 1420b, 1420c, 1420d, 1420e, etc. may contain an application that might make use of an API, or other object, software, firmware and/or hardware, suitable for use with the design framework in accordance with the invention.

It can also be appreciated that an object, such as 1420c, may be hosted on another computing device 1410a, 1410b, etc. or 1420a, 1420b, 1420c, 1420d, 1420e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for communicating information used in the communication systems using the JELVA decoder techniques, systems, and methods according to the present invention.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 14, as an example, computers 1420a, 1420b, 1420c, 1420d, 1420e, etc. can be thought of as clients and computers 1410a, 1410b, etc. can be thought of as servers where servers 1410a, 1410b, etc. maintain the data that is then replicated to client computers 1420a, 1420b, 1420c, 1420d, 1420e, etc., although any computer can be considered a client, a server, or both, depending on the circumstances. Any of these computing devices may be processing data or requesting services or tasks that may use or implicate the communication systems using the impulsive-noise decoder techniques, systems, and methods in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to communication (wired or wirelessly) using the decoder techniques, systems, and methods of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 14 illustrates an exemplary networked or distributed environment, with server(s) in communication with client computer (s) via a network/bus, in which the present invention may be employed. In more detail, a number of servers 1410a, 1410b, etc. are interconnected via a communications network/bus 1440, which may be a LAN, WAN, intranet, GSM network, the Internet, etc., with a number of client or remote computing devices 1420a, 1420b, 1420c, 1420d, 1420e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to communicate data over a network.

In a network environment in which the communications network/bus 1440 is the Internet, for example, the servers 1410a, 1410b, etc. can be Web servers with which the clients 1420a, 1420b, 1420c, 1420d, 1420e, etc. communicate via any of a number of known protocols such as HTTP. Servers 1410a, 1410b, etc. may also serve as clients 1420a, 1420b, 1420c, 1420d, 1420e, etc., as may be characteristic of a distributed computing environment.

As mentioned, communications to or from the systems incorporating the decoder techniques, systems, and methods of the present invention may ultimately pass through various media, either wired or wireless, or a combination, where appropriate. Client devices 1420a, 1420b, 1420c, 1420d, 1420e, etc. may or may not communicate via communications network/bus 14, and may have independent communications associated therewith. For example, in the case of a TV or VCR, there may or may not be a networked aspect to the control thereof. Each client computer 1420a, 1420b, 1420c, 1420d, 1420e, etc. and server computer 1410a, 1410b, etc. may be equipped with various application program modules or objects 1435a, 1435b, 1435c, etc. and with connections or access to various types of storage elements or objects, across which files or data streams may be stored or to which portion(s) of files or data streams may be downloaded, transmitted or migrated. Any one or more of computers 1410a, 1410b, 1420a, 1420b, 1420c, 1420d, 1420e, etc. may be responsible for the maintenance and updating of a database 1430 or other storage element, such as a database or memory 1430 for storing data processed or saved based on communications made according to the invention. Thus, the present invention can be utilized in a computer network environment having client computers 1420a, 1420b, 1420c, 1420d, 1420e, etc. that can access and interact with a computer network/bus 1440 and server computers 1410a, 1410b, etc. that may interact with client computers 1420a, 1420b, 1420c, 1420d, 1420e, etc. and other like devices, and databases 1430.

### Exemplary Computing Device

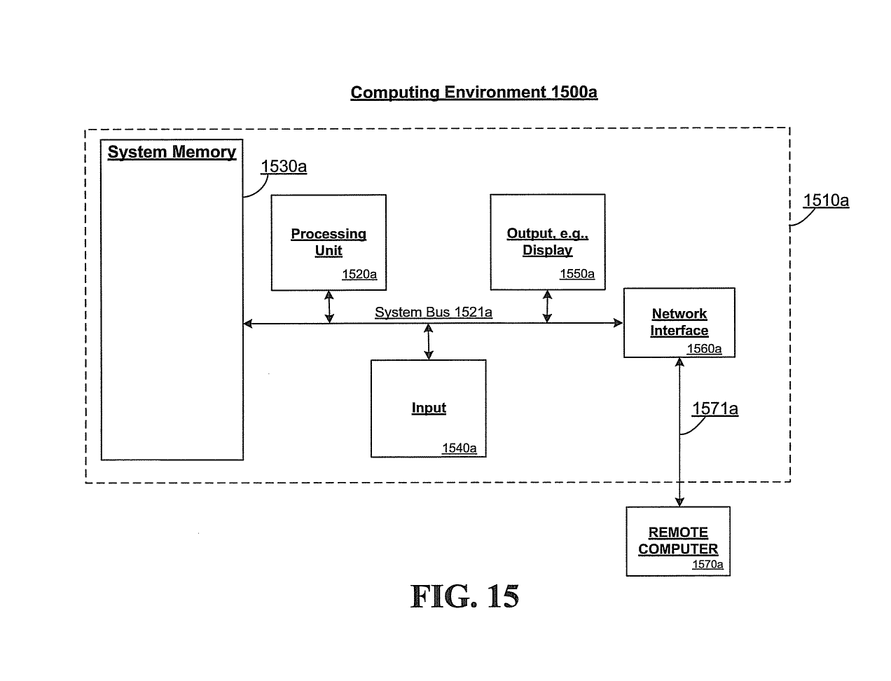

As mentioned, the invention applies to any device wherein it may be desirable to communicate data, e.g., to or from a mobile device. It should be understood, therefore, that handheld, portable and other computing devices and computing objects of all kinds are contemplated for use in connection with the present invention, i.e., anywhere that a device may communicate data or otherwise receive, process or store data. Accordingly, the below general purpose remote computer described below in FIG. 15 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the some aspects of the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 15 thus illustrates an example of a suitable computing system environment 1500a in which some aspects of the invention may be implemented, although as made clear above, the computing system environment 1500a is only one example of a suitable computing environment for a media device and is not intended to suggest any limitation as to the scope of use or functionality of the invention. Neither should the computing environment 1500a be interpreted as having any dependency or requirement relating to any one or combination of components illustrated in the exemplary operating environment 1500a.

With reference to FIG. 15, an exemplary remote device for implementing the invention includes a general purpose computing device in the form of a computer 1510a. Components of computer 1510a may include, but are not limited to, a processing unit 1520a, a system memory 1530a, and a system bus 1521a that couples various system components including the system memory to the processing unit 1520a. The system bus 1521a may be any of several types of bus structures including a memory bus or memory controller, a peripheral bus, and a local bus using any of a variety of bus architectures.

Computer 1510a typically includes a variety of computer readable media. Computer readable media can be any available media that can be accessed by computer 1510a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1510a. Communication media typically embodies computer readable instructions, data structures, program modules or other data in a modulated data signal such as a carrier wave or other transport mechanism and includes any information delivery media.

The system memory 1530a may include computer storage media in the form of volatile and/or nonvolatile memory such as read only memory (ROM) and/or random access memory (RAM). A basic input/output system (BIOS), containing the basic routines that help to transfer information between elements within computer 1510a, such as during start-up, may be stored in memory 1530a. Memory 1530a typically also contains data and/or program modules that are immediately accessible to and/or presently being operated on by processing unit 1520a. By way of example, and not limitation, memory 1530a may also include an operating system, application programs, other program modules, and program data.

The computer 1510a may also include other removable/non-removable, volatile/nonvolatile computer storage media. For example, computer 1510a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1521a through a non-removable memory interface such as an interface, and a magnetic disk drive or optical disk drive is typically connected to the system bus 1521a by a removable memory interface, such as an interface.

A user may enter commands and information into the computer 1510a through input devices such as a keyboard and pointing device, commonly referred to as a mouse, trackball or touch pad. Other input devices may include a microphone, joystick, game pad, satellite dish, scanner, wireless device keypad, voice commands, or the like. These and other input devices are often connected to the processing unit 1520a through user input 1540a and associated interface(s) that are coupled to the system bus 1521 a, but may be connected by other interface and bus structures, such as a parallel port, game port or a universal serial bus (USB). A graphics subsystem may also be connected to the system bus 1521a. A monitor or other type of display device is also connected to the system bus 1521a via an interface, such as output interface 1550a, which may in turn communicate with video memory. In addition to a monitor, computers may also include other peripheral output devices such as speakers and a printer, which may be connected through output interface 1550a.

The computer 1510a may operate in a networked or distributed environment using logical connections to one or more other remote computers, such as remote computer 1570a, which may in turn have media capabilities different from device 1510a. The remote computer 1570a may be a personal computer, a server, a router, a network PC, a peer device, personal digital assistant (PDA), cell phone, handheld computing device, or other common network node, or any other remote media consumption or transmission device, and may include any or all of the elements described above relative to the computer 1510a. The logical connections depicted in FIG. 15 include a network 1571a, such local area network (LAN) or a wide area network (WAN), but may also include other networks/buses, either wired or wireless. Such networking environments are commonplace in homes, offices, enterprise-wide computer networks, intranets and the Internet.

When used in a LAN networking environment, the computer 1510a is connected to the LAN 1571a through a network interface or adapter. When used in a WAN networking environment, the computer 1510a typically includes a communications component, such as a modem, or other means for establishing communications over the WAN, such as the Internet. A communications component, such as a modem, which may be internal or external, may be connected to the system bus 1521a via the user input interface of input 1540a, or other appropriate mechanism. In a networked environment, program modules depicted relative to the computer 1510a, or portions thereof, may be stored in a remote memory storage device. It will be appreciated that the network connections shown and described are exemplary and other means of establishing a communications link between the computers may be used.

While the present invention has been described in connection with the preferred embodiments of the various Figures, it is to be understood that other similar embodiments may be used or modifications and additions may be made to the described embodiment for performing the same function of the present invention without deviating therefrom. For example, one skilled in the art will recognize that the present invention as described in the present application applies to communication systems using the disclosed JELVA decoder techniques, systems, and methods and may be applied to any number of devices connected via a communications network and interacting across the network, either wired, wirelessly, or a combination thereof. In addition, it is understood that in various network configurations, access points may act as nodes and nodes may act as access points for some purposes. Therefore, the present invention should not be limited to any single embodiment, but rather should be construed in breadth and scope in accordance with the appended claims.

### Exemplary Communications Networks and Environments

The above-described communication systems using the decoder techniques, systems, and methods may be applied to any network, however, the following description sets forth some exemplary telephony radio networks and non-limiting operating environments for communications made incident to the communication systems using the JELVA decoder techniques, systems, and methods of the present invention. The below-described operating environments should be considered non-exhaustive, however, and thus the below-described network architecture merely shows one network architecture into which the present invention may be incorporated. One can appreciate, however, that the invention may be incorporated into any now existing or future alternative architectures for communication networks as well.

The global system for mobile communication (“GSM”) is one of the most widely utilized wireless access systems in today's fast growing communication systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the decoder techniques, systems, and methods of the present invention may be applied independently of the method of data transport, and does not depend on any particular network architecture, or underlying protocols.

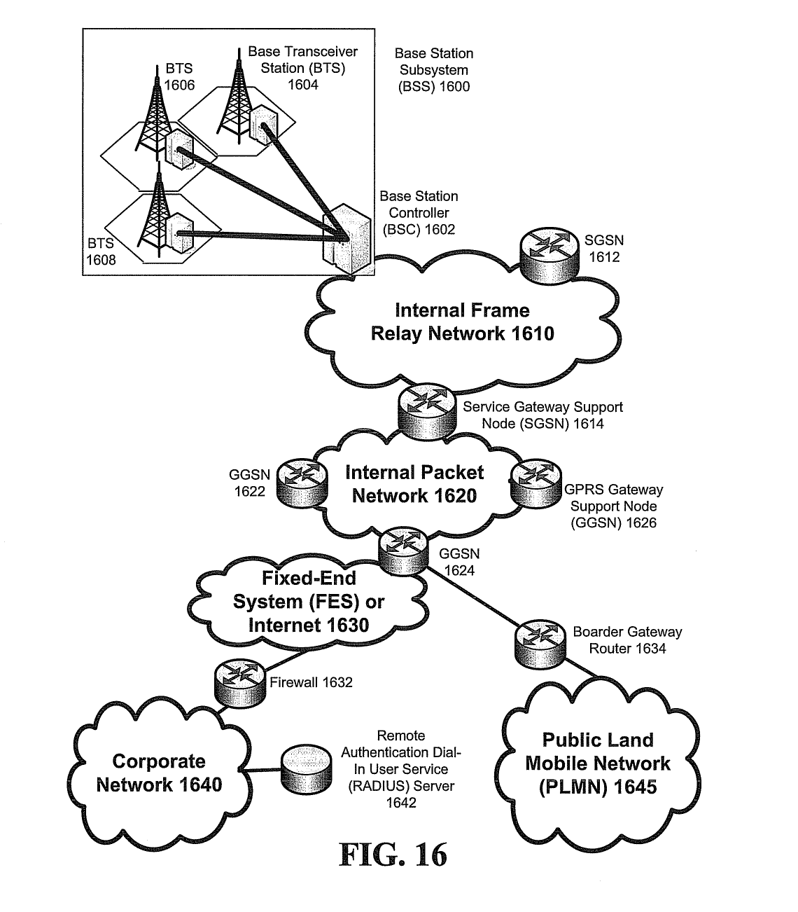

FIG. 16 depicts an overall block diagram of an exemplary packet-based mobile cellular network environment, such as a GPRS network, in which the invention may be practiced. In such an environment, there are a plurality of Base Station Subsystems (“BSS”) 1600 (only one is shown), each of which comprises a Base Station Controller (“BSC”) 1602 serving a plurality of Base Transceiver Stations (“BTS”) such as BTSs 1604, 1606, and 1608. BTSs 1604, 1606, 1608, etc. are the access points where users of packet-based mobile devices become connected to the wireless network. In exemplary fashion, the packet traffic originating from user devices is transported over the air interface to a BTS 1608, and from the BTS 1608 to the BSC 1602. Base station subsystems, such as BSS 1600, are a part of internal frame relay network 1610 that may include Service GPRS Support Nodes (“SGSN”) such as SGSN 1612 and 1614. Each SGSN is in turn connected to an internal packet network 1620 through which a SGSN 1612, 1614, etc. can route data packets to and from a plurality of gateway GPRS support nodes (GGSN) 1622, 1624, 1626, etc. As illustrated, SGSN 1614 and GGSNs 1622, 1624, and 1626 are part of internal packet network 1620. Gateway GPRS serving nodes 1622, 1624 and 1626 mainly provide an interface to external Internet Protocol (“IP”) networks such as Public Land Mobile Network (“PLMN”) 1645, corporate intranets 1640, or Fixed-End System (“FES”) or the public Internet 1630. As illustrated, subscriber corporate network 1640 may be connected to GGSN 1624 via firewall 1632; and PLMN 1645 is connected to GGSN 1624 via boarder gateway router 1634. The Remote Authentication Dial-In User Service (“RADIUS”) server 1642 may be used for caller authentication when a user of a mobile cellular device calls corporate network 1640.

Generally, there can be four different cell sizes in a GSM network—macro, micro, pico and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the invention described herein may have aspects that are wholly in hardware, partly in hardware and partly in software, as well as in software. Furthermore, aspects may be fully integrated into a single component, be assembled from discrete devices, or implemented as a combination suitable to the particular application and is a matter of design choice. As used herein, the terms “node,” “access point,” “component,” “system,” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the systems of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device.

Furthermore, the some aspects of the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture” , “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

While for purposes of simplicity of explanation, methodologies disclosed herein are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the particular embodiments of the various figures, it is to be understood that other similar embodiments may be used or modifications and additions may be made to the described embodiment for performing the same function of the present invention without deviating therefrom. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for decoding a communications signal comprising:
receiving the communication signal over a channel, the signal including a plurality of codewords, each of the set of codewords including a plurality of symbols, and one or more of the plurality of symbols are noise-corrupted;
applying a joint erasure marking viterbi decoding mode to erase one or more of the noise-corrupted symbols of the plurality of symbols;
determining whether substantially all of the noise-corrupted symbols are erased by comparing a number of erased symbols to a predetermined threshold;
dynamically switching to a list viterbi decoding mode, based in part on the determining step, the list viterbi decoding mode configured at least to calculate candidate codewords; and
terminating all decoding modes when a codeword is determined to satisfy an error checking condition, or a number of calculated candidate codewords reaches a determined maximum effective list size.

2. The method of claim 1, the receiving step includes receiving a single-carrier modulation communication signal and the one or more of the plurality of symbols are noise-corrupted includes one or more of the plurality of symbols are noise-corrupted by impulsive noise in the time domain.

3. The method of claim 1, the receiving step includes receiving a multi-carrier modulation communication signal and the one or more of the plurality of symbols are noise-corrupted includes one or more of the plurality of symbols are noise-corrupted by narrowband interference in the frequency domain.

4. The method of claim 1, the receiving the communication signal over a channel includes one of receiving the communication signal from at least one bit-interleaved coded modulating transmitter or receiving the communication signal from at least one orthogonal frequency-division multiplexing transmitter.

5. The method of claim 1 further comprising performing a simple erasure marking scheme before the applying step to erase noise-corrupted symbols having corresponding bit metrics based in part on a bit metric threshold comparison.

6. The method of claim 1, the applying a joint erasure marking viterbi decoding mode to erase one or more of the noise-corrupted symbols includes erasing the noise-corrupted symbols iteratively based at least in part on one or more marked bit erasures in the respective iteration.

7. A computer readable medium comprising computer executable instructions for performing the method of claim 1.

8. A decoding apparatus comprising means for performing the method of claim

9. A computing system for decoding a communications signal comprising:
a receiver component configured to receive the communications signal over a channel, the communications signal including a set of codewords, each of the plurality of codewords including a plurality symbols, one or more of the plurality of symbols are noise-corrupted, and the set of codewords having a plurality of respective bit positions;
an erasure marking component for determining a set of candidate codewords by marking as an erasure each of the one or more of the plurality of respective bit positions that satisfies an erasure marking criteria;
a decoder component that specifies a decoding metric for the set of candidate codewords;
a codeword determining component that determines a set of most likely codewords from the set of candidate codewords by minimization of the decoding metric, the set of most likely codewords is determined for every fixed number of erasures in the set of candidate codewords; and
a codeword selection component that selects a set of best candidate codewords from the set of most likely codewords based in part on an outer error detecting code.

10. The system of claim 9, wherein the receiver component is configured to receive the communications signal from at least one bit-interleaved coded modulating transmitter.

11. The system of claim 9, wherein the receiver component is configured to receive the communications signal from at least one orthogonal frequency-division multiplexing transmitter.

12. The system of claim 9, wherein the receiver component is configured to receive at least one of a single-carrier modulation communication signal, the one or more of the plurality of symbols are noise-corrupted by impulsive noise in the time domain, or a multi-carrier modulation communication signal, the one or more of the plurality of symbols are noise-corrupted by narrowband interference in the frequency domain.

13. The system of claim 9, wherein the erasure marking component is configured to erase noise-corrupted symbols iteratively based at least in part on one or more of the plurality of respective bit positions marked as bit erasures in a respective iteration.

14. The system of claim 9, wherein the decoding metric is one or more shortest paths in a product trellis created by extending a code trellis into a bit trellis such that each branch in the bit trellis corresponds to a single code bit.

15. The system of claim 14, wherein the codeword determining component determines the one or more shortest paths according to a parallel list viterbi algorithm.

16. The system of claim 14, wherein the codeword determining component determines the one or more shortest paths according to a serial list viterbi algorithm.

17. The system of claim 9, wherein the components are embodied in a computer readable medium for execution on a computer.

18. A decoding system comprising:
means for receiving a communication signal, the signal including one or more codewords, the one or more codewords including a plurality of symbols, and one or more of the plurality of symbols are degraded by at least non-Gaussian noise;
means for applying a joint erasure marking viterbi decoding mode to the communication signal to mark erasures in the received signal;
means for applying a list viterbi decoding mode to the communication signal to calculate a number of candidate codewords from the communication signal;
means for determining whether a codeword satisfies an error checking condition;
selection and transmission means for selecting and transmitting a codeword satisfying the error checking condition.

19. The system of claim 18, further comprising means for dynamically switching from the joint erasure marking viterbi decoding mode to the list viterbi decoding mode, based in part on dynamically determining whether substantially all of the non-Gaussian noise degraded symbols are erased;

20. The system of claim 18, wherein the means for applying a joint erasure marking viterbi decoding mode to the communication signal to mark erasures in the received signal further comprises means to mark symbol erasures iteratively based at least in part on marked bit erasures in a respective iteration.

21. The system of claim 18, the means for receiving a communication signal further comprises one of means for receiving the communications signal from at least one bit-interleaved coded modulating transmitter or means for receiving the communications signal from at least one orthogonal frequency-division multiplexing transmitter.

22. The system of claim 18, further comprising means for performing a simple erasure marking scheme to erase one or more non-Gaussian noise degraded symbols having corresponding bit metrics based in part on a bit metric threshold comparison, the means invoked prior to invoking the means for applying a joint erasure marking viterbi decoding mode and means for applying a list viterbi decoding mode.
